(19) United States
(12) Patent Application Publication
(10) Pub. No.: US 2005/0027623 A1
(43) Pub. Date: Feb. 3, 2005

(54) Method and system for no-cash electronic game in conjunction with fund raising process

(76) Inventor: Ray Otero, Rettigheim/Muhlhausen (DE)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/704,334

(22) Filed: Nov. 7, 2003

Related U.S. Application Data
(60) Provisional application No. 60/424,426, filed on Nov. 7, 2002.

(51) Int. Cl. G06F 17/60

(52) U.S. Cl. 705/30

(57) ABSTRACT

A device and method for playing a game of chance through an electronic financial transactions device, such as an automatic teller machine, wherein the game participant's entry fee is automatically deducted from the participant's account at the financial institution and wherein the winnings, if any, are automatically credited to the participant's account. The participant must specifically acknowledge his desire to play the game and must select a game entry object that will later be compared with the winning game object to determine if the participant is a winner. Coincident with playing the game, the participant makes a contribution to a donee organization, which amount can be debited from the participant's account and credited to the organization's account.

This application claims the benefit of the provisional application filed on Nov. 7, 2002, and assigned application number 60/424,426.

### FIELD OF THE INVENTION

The present invention relates to a process and a system for no-cash participation in a lottery or game of chance in conjunction with a fund raising activity, and more particularly, to the use of an electronic financial transaction device to play the game and contribute to the fund raising activity.

### BACKGROUND OF THE INVENTION

Certain methods and devices for playing no-cash lotteries and betting games are known in the art. One such method offers automatic participation by selecting the desired game on a special touch-monitor of a gaming device and filling out a participation ticket via information entry components on the gaming device. Entry mistakes can be corrected, if necessary, and the accuracy of the entered information is then confirmed. The entered data is transmitted via a transmission module from the gaming device to a gaming institution, and the participant is simultaneously provided with a printed receipt. The data transmission module is also connected to a device offering no-cash payment transactions so that the fee for the selected game can be paid without cash. For example, the gaming device includes a point of sale terminal with a card reading function for inserting a credit card, bankcard or debit card to effectuate payment. In the event the participant wins, the winnings are also paid electronically. The described gaining device is used exclusively for playing electronic lotteries and games.

Another gaming device comprises a remote lottery process and remote lottery system, which allow a player to play against a lottery institution or participate in a government-sponsored lottery, where an online connection with the lottery institution's main computer is not necessary. A gaming computer utilized by the participant ensures at least one betting opportunity and allows the player to accumulate credit through winnings and to redeem this credit, (and place bets) via a credit card, for example. When participating in a lottery, the entry elements for the particular lottery will be selected on the gaming computer.

### SUMMARY OF THE INVENTION

The present invention comprises a method for participating in a game and making a contribution to a donee organization by a game participant having an account with a financial institution. The participant initiates game participation through an electronic financial transactions device, and the game entry fee is deducted from the participant's account. The participant selects a game entry object and makes a contribution to the donee organization. A game winning object is selected and compared to the game entry objects. A participant is declared to be a winner if there is a predetermined relationship between the game entry object and the game winning object.

The invention further comprises a system for participating in a game and making a contribution to a donee organization, by a game participant having an account with a financial institution. The system comprises an electronic financial transactions device for use by the game participant in playing the game, and an account control device for charging the participant a game fee. The participant uses a data entry device to select a game entry object and to make a contribution to the donee organization. A winning object generator selects a game winning object, and a comparator compares the game entry object with the game winning object, wherein the participant is declared a winner if there is a predetermined relationship between the game entry object and the game winning object.

Additional embodiments comprise an Internet web site for effectuating the game play and the contribution and the use of a cellular or land-line telephone for plying the game and making the charitable contribution.

### BRIEF DESCRIPTION OF THE DRAWINGS

The present invention can be more easily understood and the further advantages and uses thereof more readily apparent, when considered in view of the description of the preferred embodiments and the following figures in which:

FIG. 1 illustrates a process in accordance with the teachings of the present invention; and

FIG. 2 illustrates a financial transactions device and associated components for implementing the present invention.

### DETAILED DESCRIPTION OF THE PREFERRED EMBODIMENTS

Before describing in detail the particular method and system in accordance with the present invention, it should be observed that the present invention resides primarily in a novel combination of method steps and devices related to a gaming apparatus. Accordingly, such devices and method steps have been represented by conventional elements in the drawing, showing only those specific details that are pertinent to the present invention, so as not to obscure the disclosure with structural details that will be readily apparent to those skilled in the art having the benefit of the description herein.

To participate in a lottery or a game according to the teachings of the present invention, the user accesses an electronic financial transactions device; e.g. an automatic teller machine, an electronic cash register, a point-of-sale terminal, a home-banking device, a phone-banking device or an online-banking device. These devices provide a simple, user-friendly interface for the participant's use in playing the game according to the present invention. The necessary processes for playing the game and making the charitable contribution are integrated with the banking transaction so as not to extend the transaction duration or unduly complicate the financial transaction. To participate, the user selects or the device automatically selects for him, a lottery or game entry object.

The participant's game entry object can be randomly selected by the lottery or game system, selected manually and entered on the electronic banking device by the participant or designated in advance and associated with the participant's bank account number. Alternatively, the game entry object may be generated based on the participant's bank account number, other personal indicia or a card employed by the participant to operate the electronic banking device. In yet another embodiment, the game entry object can be generated through an independent process whenever the participant accesses the electronic banking device. The participant may thus not be required to manually select a game entry object, such as a series of numbers or letters as is customary in the prior art. Other techniques for selecting the game entry object known in the art can also be employed.

Either shortly after the participant provides his lottery or game entry object or at predetermined time intervals thereafter, a winning object is selected and compared with the participant's selected game entry object to determine whether the participant is a winner. In another embodiment, a partial match of the participant's game entry object with the winning game object can also represent a win, although, for example, at a reduced payout amount.

Coincident with playing the game or lottery, the participant is invited to make a contribution to an organization, such as a civic, charitable or educational institution or another donee organization that collects and distributes donated funds and in-kind gifts to those in need. A monetary contribution can be debited directly from the participant's bank account and credited to the donee organization's account. Such contributions can be made in connection with a specific limited-duration fund raising event of the organization. In another embodiment the participant is solicited to contribute to one or more organizations, selecting the organization(s) and the amounts to be contributed to each one. Preferably, the participant is not permitted to participate in the lottery or game of chance without first electing to make a contribution to the donee organization.

As a security feature, each participant preferably has a code or code number that is assigned to the account or assigned to a specific card for accessing the account, e.g. a bank card, check card, credit card or debit card. The participant's entry of the correct code at the electronic financial transactions device validates the participant's right to play the game or lottery and make a contribution to the donee organization. As a further or alternative security measure, an additional personal code can be used, which is commonly known as a code number, code word or a PIN (personal identification number), consisting of an alphabetical, numerical, or alphanumerical combination of digits of varying length. Proof of access to play and contribute can be determined by other means as well, e.g. a distinguishing body feature, such as fingerprints or voiceprints, using known biometrics devices and characteristics. In yet another embodiment, a first code word can be required to access accounts through the electronic financial transactions device, while a second code word is required to participate in the game or lottery and make the charitable contribution.

Preferably the user of the electronic financial transactions device is automatically informed of the opportunity to participate in the game or lottery, for instance with an appropriate text or graphical message on a display of the electronic financial transactions device or by an acoustic signal produced thereby. The message can set forth the process for playing the game, the terms and conditions of the game, the probability of winning and details of the charitable contribution aspect of the transaction.

Since participating in the game and making the contribution requires only an acknowledgement by the user of the financial transactions device, there is presented a simple, user-friendly process, leaving little opportunity for errors or cheating, which would be extremely detrimental to the legitimacy of the game. Since the backend process that controls the game play and the contribution is in turn controlled by secure components and elements, misuse and manipulations by unauthorized third parties is nearly impossible, making this a secure gaming and contribution process. The financial transactions devices to which the game and contribution features can be added are widespread, easily accessible and user friendly, providing ease of use for potential participants.

It will be appreciated by those skilled in the art that the gaming process taught by the present invention is also easily adaptable to a personal computer configured to provide home banking or online banking transactions via a modem or other device for assessing the user's bank computers via the public switched telephone network, the cable television network or a wireless access device.

The electronic banking device offering a gaming opportunity in accordance with the present invention includes an entry option to request participation in the lottery or other game of chance and an entry option to make a contribution. These options can be provided, for example, by a confirmation button or unique set of keypad entries, so that no device hardware alterations are required to implement the present invention. It is suggested that most required modifications can be accomplished through simple software changes.

The electronic banking or financial transactions device of the present invention also includes preferably a means for visual or acoustical display of the opportunity to participate in the game, e.g. by means of a monitor that will advise the user of the lottery and provide all required information for participating and making a contribution. The device should preferably include an access protection feature such as the magnetic strip card reader and/or a personal code word receiving device.

In accordance with the teachings of the present invention, the aforementioned electronic financial transactions device can be part of a system for the no-cash electronic playing of game of chance, where the game operator determines at least one winner over a predetermined time interval. For instance, the winning number can be determined by a random selection mechanism and then compared through a corresponding device for complete or partial matching with an account-assigned participant's code number of at least one participant in the game.

The invented system preferably also includes a control, security or identification-feature for identification of the participant by means of inserting a magnetic strip card into an electronic financial transactions device and/or entering a personal authorization code.

The provided lottery or game of chance can be configured to operate serially, such that when one game ends another one begins. In another embodiment a plurality of games or lotteries can be made available concurrently such that the participant must select a game or lottery to play.

In a preferred embodiment, a contest or game bank account receives the game or lottery fee from a participant's bank account. When the participant indicates that she wishes to play the lottery or game, by the entry of appropriate information as discussed above, the wagered amount is transferred from the participant's account to the contest account and a date/time entry is made in the participants account, wherein the entry represents the date and time that the participant played the game or lottery. One or more winners are selected later by a database access statement that identifies and pulls preselected winning account numbers from among the list of game participating account holders.

In an alternative embodiment, two databases are created. A first database includes contest information, such as a contest number, beginning and end dates for the contest, an indication as to whether the contest is currently available for play and other desired contest information. A second database comprises a participants or entrants database for each active game or contest and includes each entrant's account number, the date and time of the participant's contest entry, a participant's game entry number and winnings information.

As a participant enters one or more active contests, his game entry number or game entry object is added to the participants or entrants database. When the game or contest is concluded, the participants database is closed such that no additional entries are permitted. At that time, a new contest may be activated and a participants database created for the new contest.

After the contest is closed, a database query pulls all entrant account numbers and play dates from the entrants database. The account numbers are processed and a contest fee (for example, $1) is transferred from each participant's bank account to the contest account. Alternatively, the contest fee can be transferred to the contest account when a participant selects the option to participate in the game. A winner is selected from among the entrant account numbers by randomly selecting one of the account numbers or by other techniques known in the art.

The winnings purse or prize can be determined in advance by the game operator. If the game comprises a government-run lottery, the purse will be determined by the lottery rules. For privately operated games, the operator can determine a process for calculating the prize. For example, the game operator can elect to pay out 50% of the amount wagered, or the pay-out can be divided among a number of winners, with each winner receiving a share of the total pay-out. Prizes can also include consumer items. Additionally, the game winners can be selected over a time interval with the prize value increasing with time, where the final prize is awarded when the game is deactivated.

Winners can be selected using several different processes. In one embodiment a predetermined number of winners are randomly selected from the list of contestants when performing the database query. Alternatively, a number can be assigned to each contest or game entry, and a random number selected (using known techniques) from among the assigned numbers. If more than one winner is desired, a plurality of random numbers can be generated, with each random number associated with one of the game entries.

As can be appreciated by those skilled in the art, various games, contests and lotteries can be offered through the electronic financial transactions device and various techniques and processes can be employed to interface the game elements to the transactions device.

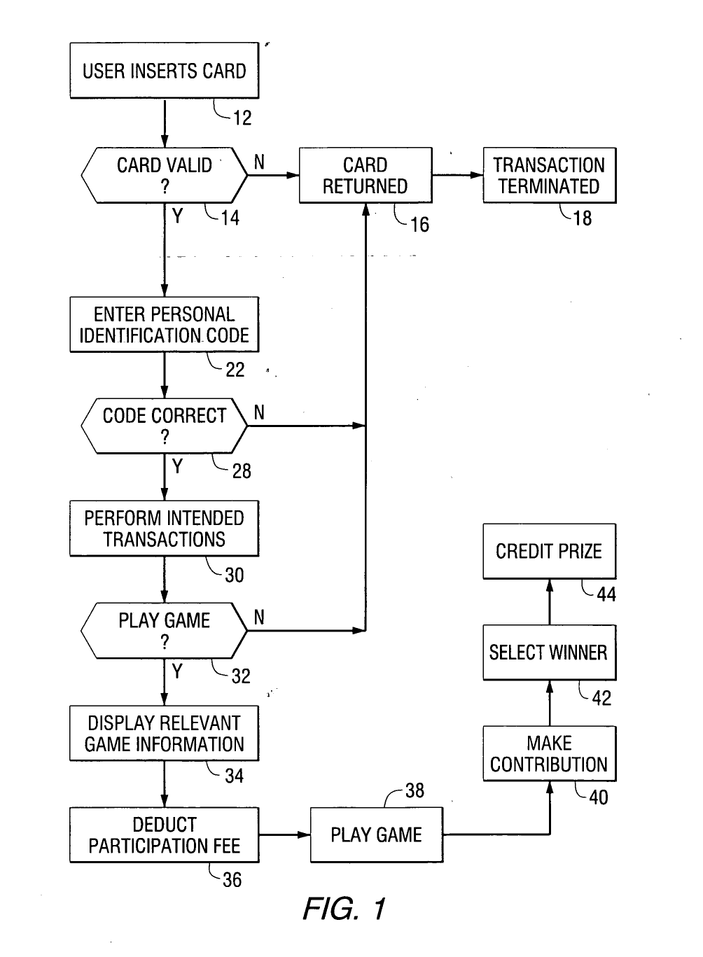

FIG. 1 illustrates the process for making a charitable contribution and playing a game, sweepstakes or contest in accordance with the present invention. When a customer of a bank or credit facility intends to replenish his cash supply and/or wishes to participate in a game and make a contribution via an electronic financial transactions device, he inserts his bank debit card, credit card or similar financial transaction card into the card reader (as shown at a step 12) of an electronic financial transactions device. Preferably, the device is equipped with various control, security or identification features to determine the validity of the card. If the card is determined to be invalid, the card is returned at a step 16 and the transaction terminated at a step 18.

At a step 22, the participant enters a PIN or other uniquely identifying numbers or characters. PIN entry or another validation process can be used to confirm that the present user of the card is in fact the owner or a valid user of the card. User validation can also be performed by evaluating the user's fingerprint or voiceprint, for example, wherein suitable fingerprint or voiceprint input and analysis devices are incorporated into the electronic financial transactions device.

At a decision step 28 the user is determined to be a valid or an invalid user. If the user is not validated, processing proceeds from the decision step 28 to the step 16 where the card is returned and then to the step 18 where the transaction is terminated.

If the result from the validation decision step 28 is affirmative, the process moves to a step 30 where the user performs the intended financial transaction.

After the transaction is complete (or at any time after the user is determined to be a valid user of the card), she is automatically informed of the opportunity to participate in a lottery or game and contribute to a non-profit or charitable organization, as illustrated at a decision step 32. For example, a text message such as, “Would you like to donate and win?” or “Do you want to give and win?” is displayed on a screen of the financial transactions device. In one embodiment the question is displayed as the transaction is being processed. In a situation where the participant is withdrawing cash from the device, the message can be displayed before the cash is presented to the participant. If the user declines to play the game and make a contribution, the card is returned at the step 16 and transaction is terminated at the step 18.

If the user accepts the opportunity to participate, processing proceeds to a step 34 where the probability of winning, game rules and other pertinent information is displayed. At a step 36, the participation fee (in one embodiment a modest fee of $1.00) is automatically deducted from the user's account and transferred into a game account. A portion of the fee or an additional amount deducted from the user's account can be credited to the donee organization's account. In another embodiment, the user is given a second chance to decline participation after the rules and participation fee are displayed at the step 34.

Finally, at a step 38 the user participates in the game. This may be accomplished by the participants selection of a number or game entry object, or the user can request that a game entry object be selected for her. As is known by those skilled in the art, there are many different objects that can be used for game entry selection. The most common such object is one or more numbers between two predetermined limits. The game rules, as determined by the game operator, will set forth the nature of such game entry selections and the process for selecting one or more such objects with which to participate in the game. Further, after entering his selected objects, the user will have the opportunity to confirm the chosen selections before the objects are officially entered into the game.

Unlike known no-cash electronic processes for playing games, this method does not require the participants to obtain and/or fill out any special forms, and thereby simplifies participation and eliminates opportunities for errors in completing such forms. Furthermore, no subsequent participation confirmation must be issued because this is accomplished at the electronic banking device. Use of existing automatic teller machines, which offer a high level of security, significantly reduces the opportunities for misuse and manipulation of the gaming process. Since in one embodiment the process of the present invention is embodied in software commands, the presently available automatic teller machines and other electronic financial transactions devices can adequately accommodate the gaming function.

At a step 40 the participant's card number or other participant identifying indicia is sent to the donee's fundraiser database. Also, a contribution is debited from the participant's account and credited to the donee organization's account. It is known that there are other processes for effectuating the contribution. For example, the contribution amount can be charged against the participant's credit card rather than debited directly from his bank account.

At a step 42 one or more winners are selected from the game or contest database. As described elsewhere herein, a game winner can be determined immediately after the participant enters or selects her game entry object or one or more winners can be determined at a later date from among the pool of game participants. At a step 44, the game prize is credited to the winners account and the winner is informed of the prize credit.

At predetermined time intervals, for example, one week or one month, the game operator (in one embodiment a bank or other credit institution providing the electronic financial transactions device or an organization independent of the financial services provider operating under license therefrom) will determine a winner from among all the participants. This can be accomplished by simply selecting one of the entries or by randomly selecting certain winning objects (for example, one or more numbers between the two predetermined limits) and comparing the winning number(s) with those of the participants. In yet another embodiment a random selection device will determine a number of a certain length (six digits or characters, for example), and compare this number to the account numbers, card numbers, transactions numbers or personal codes of the participants in search of a match. In still another embodiment a winning entry is randomly selected from among all the game entry objects. In any case, once a match is identified, the game winnings are automatically transferred into the account of the winning participant as indicated at the step 44. Of course, the winning prize or jackpot is at the discretion of the game operator, so long as the amount or a method for derivation thereof is set forth as indicated at the step 34. A subsequent bank statement of the wining participant will document the relevant account transactions, including the entry fee, the charitable contribution and the winning jackpot. The winner will also be notified by correspondence, e.g. surface mail or email if the users email address has been previously provided.

In other embodiments of the present invention, multiple winners can be selected, where for example, a first prize win requires matching all of a predetermined number of game entry object characters (six, for example) (or all of a predetermined number of objects from among a set of game entry objects), while matching a fewer number of object characters is statistically more likely and therefore results in a prize of a lesser amount. For example, matching five digits for a second prize, and four digits for a third prize and so on. It is also possible to select several numbers at random as the winning numbers and use these for determining the individual winners.

The user can be presented with a plurality of games to play via a monitor or other suitable display element of the electronic financial transactions device. The user will select the game or games in which she desires to participate by activating the appropriate key or keys on a keypad or other suitable data entry device. After making a selection, the game participant enters any required information for processing the participation, for example, selecting her game entry object, correct the entries if needed, and validate by entries activating a confirmation process. Subsequently, the participation fee will automatically be deducted from the participant's account. After the determination of one or more winners, which will happen within certain predetermined time intervals, the winning prize will automatically be placed into the winner's account.

In another embodiment, the present invention can be implemented in an Internet-based system where the user participates in the game at an Internet web site or portal. The user participates in the game by charging the entry fee to a credit card or to an account maintained at the web site, or by accessing the participant's bank account and debiting the amount from that account. Advantageously, most Internet sites now offer a secure connection for processing of financial transactions. As in the embodiments discussed above, the participant selects one or more game entry objects and these selections are recorded for later comparison with the winning entries, as selected by the game operator.

In yet another embodiment, a cellular telephone user can participate in the game and make a contribution by calling a host site having a predetermined telephone number. A recorded message at the host site invites the user to participate in the game and make a charitable contribution. The user selects a game entry object using the telephone keypad or from alphanumeric characters displayed on a telephone display. The game participation fee (and the contribution if the user so elects) is deducted from the user's bank account or charged to the user's credit card. In yet another embodiment, a wire application protocol system can be used as a link with the Internet if the opportunity to play and win is sponsored by an Internet service provider or by the charitable organization through its web site.

In a preferred embodiment the participant's opportunity to play the game or enter the contest is dependent on the charitable contribution. That is, as a condition precedent to playing the game with an opportunity to win a prize, the participant must first commit to making a charitable contribution. Thus the chance to play and win a prize may positively influence the influx of charitable contributions to donee organizations.

Contributions to such charities will be a part of the backend database program. Operators of the system can use available information technology to integrate the game and contribution functionality as part of the electronic financial transactions device. Multiple donee organizations can be supported by creating an account for each such organization.

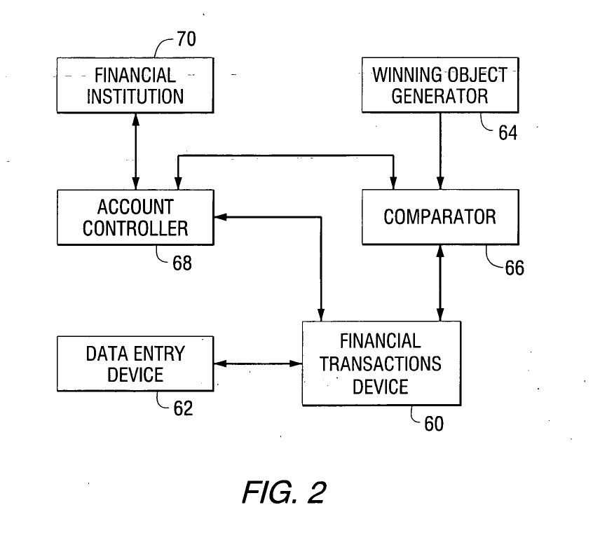

FIG. 2 illustrates a financial transactions device 60 and associated components for implementing the process of participating in a game or contest and making a contribution to a donee organization according to the present invention. In certain embodiments, the elements depicted in FIG. 2 can be incorporated in the financial transactions device 60, rather the separated therefrom as shown. The user enters information into the financial transactions device 60 through a data entry device 62. Such information includes, for example, the personal identification code and the game entry object as described above. When a game-winning object is selected in a winning object generator 64, a comparator 66 compares the game entry objects of the participants with the winning object to identify one or more game winners.

An account controller 68 interfaces the financial transactions device 60 to a financial institution 70 for executing the financial transactions initiated by the user, including those associated with a conventional financial transaction initiated by the user at the device 60 and those transactions related to user participation in the game and contributions to the donee organization.

While the invention has been described with reference to a preferred embodiment, it will be understood by those skilled in the art that various changes may be made and equivalent elements may be substituted for elements thereof without departing from the scope of the present invention. In addition, modifications may be made to adapt a particular situation to the teachings of the invention without departing from the essential scope thereof Therefore, it is intended that the invention not be limited to the particular embodiment disclosed as the best mode contemplated for carrying out this invention, but that the invention include all embodiments falling within the scope of the appended claims.

1. A method for participating in a game and making a contribution to a donee organization by a game participant having an account with a financial institution, the method comprising:
(a) initiating game participation through an electronic financial transactions device;
(b) deducting the game entry fee from the participant's account;
(c) selecting a game entry object;
(d) making a contribution to the donee organization;
(e) selecting a game winning object;
(f) comparing the game entry object with the game winning object; and
(g) declaring the participant to be a winner if there is a predetermined relationship between the game entry object and the game winning object.

2. The method of claim 1 wherein the winner is awarded a monetary prize and further comprising a step (h) crediting the monetary prize to the participant's account.

3. The method of claim 1 further comprising a step (a1) determining that the participant is an authorized user of the electronic financial transactions device.

4. The method of claim 3 wherein the step (a1) further comprises:
inserting a card, having incorporated therein a first code, into the electronic financial transactions device;
entering a second code into the electronic financial transactions device by the participant; and
authorizing the participant to use the electronic financial transactions device if there is a predetermined relationship between the first code and the second code.

5. The method of claim 4 wherein the first code is incorporated into a magnetic strip on the card, and wherein the second code is entered on a keypad of the electronic financial transactions device.

6. The method of claim 3 further comprising a step of (a2) determining that the participant is authorized to participate in the game.

7. The method of claim 1 wherein the step of making a contribution to the donee organization further comprises assigning a portion of the game entry fee to the donee organization.

8. The method of claim 1 wherein the step of making a contribution to the donee organization further comprises withdrawing a monetary amount from an account of the participant and depositing the monetary amount in an account of the donee organization.

9. The method of claim 1 wherein the electronic financial transactions device comprises an automatic teller machine.

10. The method of claim 1 wherein the electronic financial transactions device further comprises a display and further comprising the step (a1) providing a game description on the display.

11. The method of claim 1 wherein the step of selecting a game winning object further comprises randomly selecting a game winning object.

12. The method of claim 1 wherein the game entry object comprises one or more characters, and wherein the step of selecting a game entry object further comprises selecting the one or more characters by the participant.

13. The method of claim 1 wherein the account is identified by an account number, and wherein the step of selecting the game entry object further comprises deriving the game entry object from the account number.

14. A system for participating in a game and making a contribution to a donee organization, by a game participant having an account with a financial institution, the system comprising:
an electronic financial transactions device for use by the game participant in playing the game;
an account control device for charging the participant a game fee;
a data entry device for use by the participant to select a game entry object and to make a contribution to the donee organization;
a winning object generator for selecting a game winning object; and
a comparator for comparing the game entry object with the game winning object, wherein the participant is declared a winner if there is a predetermined relationship between the game entry object and the game winning object.

15. The system of claim 14 wherein the winning object generator determines a monetary game prize, and wherein the account control device credits the account of the winner with the monetary game prize.

16. The system of claim 14 wherein the account control device credits an account of the donee organization with the contribution.

17. The system of claim 14 wherein the account control device debits the account of the game participant with the game fee.

18. The system of claim 14 including a security device for requiring the participant to enter a code and for determining if the participant is an authorized user of the electronic financial transactions device in response to the code and for allowing the participant to participate in the game if authorized.

19. The system of claim 14 wherein the data entry device prevents the participant from selecting a game entry object unless the participant makes a contribution to the donee organization.

20. A method for a participant to play a game having a game entry fee and to make a contribution to a donee organization, the method comprising:
(a) connecting to an Internet web site;
(b) initiating participation in the game;
(c) charging a game entry fee to an account of the participant;
(d) making a contribution to the donee organization
(e) selecting a game entry object;
(f) selecting a game winning object by a game operator;
(g) comparing the participant's game entry object with the game winning object; and
(h) declaring the participant to be a winner based on a predetermined relationship between the participant's game entry object and the game winning object.

21. The method of claim 20 wherein the step of connecting to the Internet web site further comprises connecting to the Internet web site through a cellular telephone.

22. The method of claim 20 wherein the step of charging a game entry fee further comprises charging the game entry fee to a credit account of the participant.

23. The method of claim 20 wherein the step of charging a game entry fee further comprises charging the game entry fee to an account of the participant at a financial institution.

24. The method of claim 20 wherein the step of making a contribution further comprises charging the contribution to a credit account of the participant.

25. The method of claim 20 wherein the step of making a contribution further comprises charging the contribution to an account of the participant at a financial institution.

26. A method for a participant to play a game having a game entry fee and to make a contribution to a donee organization, the method comprising:
(a) connecting to a host site via a telephone;
(b) initiating participation in the game;
(c) charging a game entry fee to an account of the participant;
(d) making a contribution to the donee organization
(e) selecting a game entry object;
(f) selecting a game winning object by a game operator;
(g) comparing the participant's game entry object with the game winning object; and
(h) declaring the participant to be a winner based on a predetermined relationship between the participant's game entry object and the game winning object.

27. The method of claim 26 wherein the host site comprises an Internet web site.

28. The method of claim 26 wherein the step of charging a game entry fee further comprises charging the game entry fee to a credit account of the participant.

29. The method of claim 26 wherein the step of charging a game entry fee further comprises charging the game entry fee to an account of the participant at a financial institution.

30. The method of claim 26 wherein the step of making a contribution further comprises charging the contribution to a credit account of the participant.

31. The method of claim 26 wherein the step of making a contribution further comprises charging the contribution to an account of the participant at a financial institution.
